(19) United States
(12) Patent Application Publication
(10) Pub. No.: US 2014/0284892 A1
(43) Pub. Date: Sep. 25, 2014

(54) Tipping Support for a Stroller

(71) Applicant: Jennifer Farina, Bethpage, NY (US)

(72) Inventor: Jennifer Farina, Bethpage, NY (US)

(21) Appl. No.: 13/846,995

(22) Filed: Mar. 19, 2013

(51) Int. Cl. B62B 9/12; B62B 9/08

(52) U.S. Cl. CPC B62B 9/12; B62B 9/08
USPC 280/47.38

(57) ABSTRACT

A detachable tipping support device used to prevent strollers from tipping over because of a disproportionate rear weight is disclosed. The support device comprises a telescoping kickstand shaft and a detented, spring biased stroller connection means. The kickstand shaft comprises a movable grip housing an internal spring biased mechanism that locks the shaft into either a deployed or stored state. A high friction base at the kickstand shaft is used to stabilize the device against a surface and prevents sliding along a support surface when supporting the weight of a tipping stroller. The stroller connection means comprises a clamp having a first and second clamp member. The clamp members envelope a rear post of a stroller and are drawn together via fasteners to secure to the post. The kickstand shaft is then pivotable mounted to the clamp members and secured into a given position by the spring biased mechanism.

### BACKGROUND OF THE INVENTION

1. Field of the Invention

The present invention relates to a stroller and a structural tipping support body therefor. More specifically, the present invention pertains to a pivoting support body with a high friction base that connects to the rear post of a stroller to help prevent a stroller from tipping and provides a spring-loaded tipping support therefor.

Many parents or caregivers use a stroller to transport a child. When a caregiver uses a stroller it is likely that he or she also carries multiple bags, including items such as a diaper bag, a day bag, groceries or a purse. However, most strollers do not have an area for bag storage. The situation requires the person pushing the stroller to carry the bags on his or her shoulders or to balance a bag on the handles of the stroller but the bags need to be placed somewhere when the stroller is stopped. Otherwise, the caregiver will not have the ability to properly tend to the child. This everyday occurrence presents an issue for strollers, particularly umbrella strollers, whose structure is not designed to support weight along its handle area.

Umbrella strollers are light-weight, compact, and collapsible baby carriages with four wheels and high mounted handles for a user to push upon. It is an easily collapsible device that folds into itself for compact storage. The compact design of an umbrella stroller prevents the stroller from having areas for bags to be placed or stored. A common solution for the issue is to place the bags on the handle of a stroller. As a consequence, if the stroller's handles are released by the user then the stroller can easily tip over because of disproportionate weight placed on the rear of the stroller. This is both problematic and dangerous for the user. First, it limits what can be carried while the stroller is in use. Second, the stroller cannot adequately support additional rear weight when in a stationary position. Finally, the issue can become dangerous if a child is in the stroller and weighs more than the supported bags. The additional rear weight from a bag on the handle could very easily cause the stroller to tip over while the child is in the stroller, resulting in an injury to the child.

Stroller support means have been designed and disclosed in the prior art. The majority of the devices relate to kick stand support members that connect to a stroller. The devices provide tipping support for weight placed in the rear of the stroller. In addition to a kick stand support member, the present invention has other innovative features including a spring loaded grip to stabilize the tipping support member and a telescopic shaft with an adjustable length.

The present invention relates to an improved support member for a stroller that prevents tipping. It improves upon assembly elements to allow for a portable support member with an improved detachable connection to the stroller. Specifically, the present invention comprises an adjustable telescopic member with a connection means for securing the device to the rear post of a stroller. The connection means enables the telescopic member to be positioned downwardly along the rear post of a stroller. The telescopic member is stabilized by an internal spring system that moves the member securely into detents present on the stroller connection means. Further, the connection means allows for a quick attachment and set up into a deployed position.

2. Description of the Prior Art

Devices have been disclosed in prior art that relate to supports. This includes devices that have been patented and published in patent application publications, and generally relate to tipping support devices having support means or other diverging elements as it relates to the present invention. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,474,664 to Luttway describes an attachable support member mountable to a stroller, whereby the support member extends diagonally away from the back of the stroller and makes contact with a surface. The attachable device comprises two elongated members together forming a telescopically deployable member held in a stored position by a restraining member that is attached to a frame and cross-member section. The frame attaches to the stroller by a connection means. The device's telescoping member's length can be adjusted and secured into a rigid position by an adjustment lever. The Luttway device's cross-member section attaches to the frame and telescoping member for additional support. When the telescoping member is in the deployed position, the cross-member section is pushed into a locked and rigid position. While the Luttway device is similar in nature to the present invention, the present invention provides a removable device and does not require installation, whereas the Luttway device has a connection means that makes removal difficult. Additionally, the present invention improves the support element by not requiring a frame and cross-member section. Further, the present invention improves the base support of the Luttway device with the addition of a rigid high friction base.

U.S. Pat. No. 7,014,203 to Liu describes a kick stand to hold an umbrella stroller upright when in its stored position. The device comprises two links connected to a rear post of a stroller, a pedal, and a kick stand support. The top end of the kick stand is pivotably connected to the top link and the bottom link is pivotably connected to a centrally located portion of the kick stand. The two links form a permanent connection means to the stroller. The device is deployed when the stroller is in its stored position. The user operates the Liu device by pushing a pedal downward. This action moves the kick stand into its operational position. To properly use this device, however, presents practical limitations. The design of the Liu device requires that it be installed onto a rear post through two permanent connection means. This presents an issue if holes are drilled into the rear post because the structural integrity of the post will become compromised. The present invention does not require structural modifications to the stroller and most notably, it is detachable. Additionally, the present invention's function is different from the Liu device. The present invention is used to support disproportionate rear weight whereas the Liu device is intended only support the weight of a stroller. Also, the present invention is intended for use when the stroller is in its operational position while the Liu device is used when the stroller is in its closed position.

U.S. Pat. No. 7,234,711 to Gordon is a variation on the support member for a stroller. The Gordon device is a stand support that comprises two curved bars with clamp connection means to near vertical rear posts of a stroller. The bars extend outwardly behind the stroller. When the stroller is in a stationary position, the bars make contact with the ground and support rear weight from the stroller. For storage, the Gordon device can be moved by loosening the clamps and folding the bars inward. The Gordon device has limitations based on its design, especially with user movement. For example, as a person pushes the stroller, if the bars are left in the support position then the device interferes with the stride of the person. This can cause the person to trip and fall while using the stroller. Another limitation of the Gordon device is the requirement of a near vertical rear post. The requirement can prevent the Gordon device from installation on certain strollers. The present invention improves on the limitations of the Gordon device. The most practical improvement is the present invention is detachable and thereby allows the stroller to be placed in its stored position. Another improvement is the present invention can attach to any bar or post located on the stroller.

One final support member is U.S. Pat. No. 3,893,687 to Victor. The Victor device is a mountable attachment to a hand truck used to help balance weight when a hand truck is not in its stationary position. The device supports and balances weight previously added onto a hand truck. The device connects to a hand truck by a bracket means to the upper portion of the rear side of the hand truck. From the connection point with the hand truck, a free swinging support member is held in place by a locking means. The swinging member comprises an elongated strut within a sleeve that moves telescopically. There is a tightening element on the sleeve to hold the swinging member at any desired length. The length of the support member is adjustable by sliding the strut to a desired position within the sleeve then torquing the tightening element. The swinging member also has a base that comprises a stabilizing foot. The locking means is operated by a hand release mechanism that allows the support member to be released. Once released, the support member is set at a desired angle with the hand truck. The use of the support member is limited because the Victor device must be mounted to a certain section of a hand truck whereas the present device is attachable at various parts of a stroller.

The present invention is a new and improved stroller tipping support body that provides a pivotable support member with a high friction base, an adjustable length, and a means of stabilizing the support member into either a working or stored state while deployed. The device provides a stable means to prevent a stroller from tipping when deployed and a stowable structure when desired. The present invention has been shown to improve the stability of a stroller when additional, disproportionate weight is added to the rear of the stroller. In light of the devices in prior art, it is submitted that the present invention substantially diverges in design elements from the prior art and consequently it is clear that there is a need in the art for an improvement to existing devices. In this regard the instant invention substantially fulfills these needs.

### SUMMARY OF THE INVENTION

In view of the foregoing disadvantages inherent in the known types of stroller support members now present in the prior art, the present invention provides a tipping support body that can be utilized to provide convenience to the user when he or she places the attachable stroller support member onto a stationary stroller to provide tipping support for weight added to the rear of a stroller.

It is therefore an object of the present invention to provide a new and improved stroller tipping support body device that has all of the advantages of the prior art and none of the disadvantages.

It is another object of the present invention to provide a tipping support body having a universal stroller attachment means that supports a pivotable kickstand structure, a detented support for the kickstand itself, and a high friction base stable contact with a support surface while deployed.

Another object of the present invention is to provide a stroller support body that is compact, wherein the assembly includes a telescopic kickstand structure that reduces in length of the device when deployed or when in a stored position.

Another object of the present invention is to provide a stable support means for the stroller having defined detents and a spring biased mechanism for locking the assembly into either a stored or deployed state.

Yet another object of the present invention is to provide a stroller support body that is readily detachable and requires no modification to an existing stroller structure, wherein the present invention comprises a clamp connection means to a stroller post.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the preferred embodiment of the present invention, the tipping support body is show in its deployed position and not attached to the rear post of a stroller.

FIG. 2 shows a perspective view of the preferred embodiment of the present invention in its deployed position attached to a rear post of a stroller.

FIG. 3 shows a view of the stroller connection means of the present invention.

FIG. 4 shows a cross-section view of the present invention's grip and the spring biased kickstand stabilization means, which locks the kickstand into a given detent within the stroller connection means.

### DETAILED DESCRIPTION OF THE INVENTION

Reference is made herein to the attached drawings. Like reference numerals are used throughout the drawings to depict like or similar elements of the tipping support body. For the purposes of presenting a brief and clear description of the present invention, the preferred embodiment will be discussed as a tipping support body attached to the rear post of a stroller. The figures are intended for representative purposes only and should not be considered to be limiting in any respect.

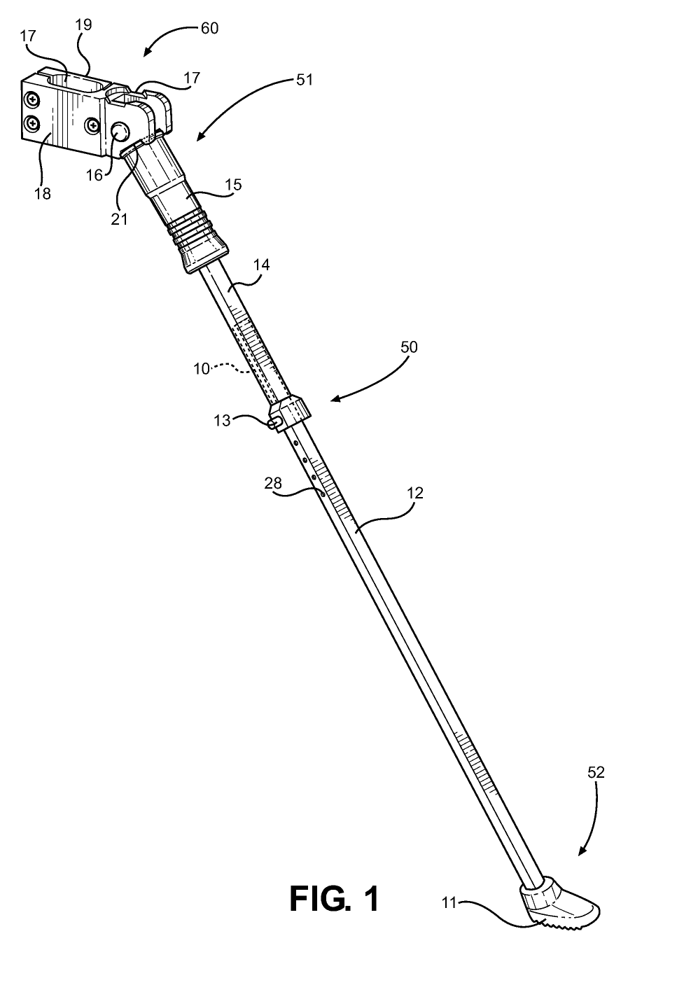

Referring now to FIG. 1, there is shown a perspective view of the preferred embodiment of the present invention in a deployed position. The tipping support device comprises an elongated kickstand shaft having a first 51 and second 52 end. The shaft is formed from a unitary member or preferably from a first 12 and second 14 telescoping member. The telescopic members move slideably within one another to adjust the overall length of the shaft. As the first telescopic member 12 slides, a portion 10 of the member 12 moves into the internal open volume of the first telescopic member 14. The first telescopic member 12 slides until the desired length is reached, whereafter the member 12 is secured by a telescoping lock mechanism 50 that secures the two members together into a static position. A push pin or set screw 13 is secured into an aperture 28 along the side of one of the telescoping members to lock the assembly together. Overall, the telescopic shaft comprises a first 51 and second end 52, the second end 52 having a high friction base 11 connected thereto. The high friction base 11 is used to stabilize the shaft as it makes contact with a support surface, while the first end 51 is secured to the stroller connection means 60 by way of a pivot point 16.

The stroller connection means 60 connects to the rear post of a stroller and is adapted to support the assembly in a static position therealong. The stroller connection means 60 comprises a clamping assembly, a pivot point 16 for the elongated kickstand shaft, and at least two detents 17, 21 for securing the kickstand shaft into either a working or stored position while deployed. The stroller connection means 60 may comprise a number of different designs for accommodating the unique design of a rear stroller leg, wherein the leg is clamped and the device remains statically supported therealong. In a preferred embodiment, a first clamp member 18 is disposed opposite of a second clamp member 19 to form an open throughway 17 therebetween and aligned apertures for fasteners to secure the members together. The two clamp members surround the rear leg or post of a stroller and are secured together via a set of fasteners. The stroller connection means supports the kickstand pivot point 16 and includes a deployed detent 21 and a stored detent 17 for securely supporting the kickstand in either position. In a preferred embodiment, the telescopic shaft 50 rotates about the pivot point 16 and between the two detents when the user deploys the kickstand shaft or when stowing the assembly against the stroller rear post. The rotation of the telescopic shaft 50 enables the support member to be placed into a stored or deployed position as it is in use with a stroller. Once the stroller connection means 60 is attached to a rear post 30, the telescopic shaft 50 can be placed into its deployed position to support an additional rear weight placed on the stroller to prevent tipping. To secure the first end 51 of the kickstand shaft into the given detent 17, 21, a spring biased grip 15 is provided that secures the first end 51 firmly into the given detent of choice.

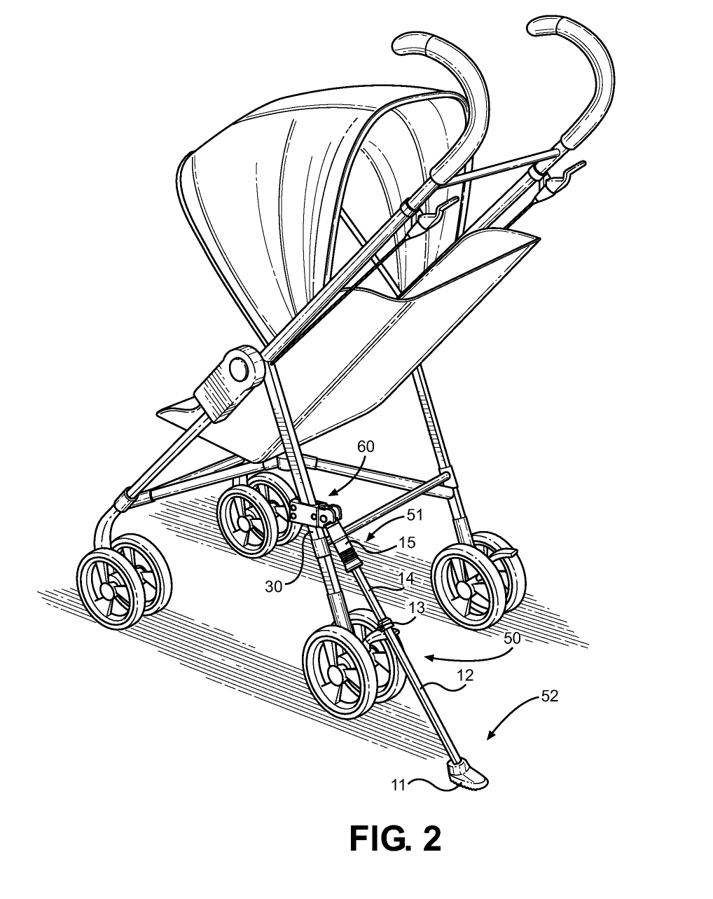

Referring now to FIG. 2, there is shown a perspective of the present invention in its deployed position attached to a rear post 30 of a stroller. The device connects to the rear post 30 by its stroller connection means 60. The connection means 60 is secured about the rear post 30 using multiple fasteners 20 that preferably draw a first and second clamp member together around post 30. Once secured, the stroller connection means 60 provides static support for the kickstand shaft, which is capable of rotating about its pivot point between a stored detent 17 and a deployed detent 21. The kickstand shaft 50 is held securely in either detent by the grip 15. As shown, in its deployed position, the device extends downwardly to the ground. The kickstand shaft 50 is stabilized by the deployed detent 21 and prevented from rotating about its pivot point. The high friction base 11 of the shaft second end 52 makes contact with a surface and supports the stroller in its upright position. As the high friction base 11 is in contact with a surface, it counteracts any weight added to the rear of the stroller. The shaft 50 provides a rigid support to prevent the stroller from tipping backwards. When not required, the shaft 50 can be put into a stored position, angled upwards and against the body of the stroller. To be put the device into a stored position, the shaft 50 is rotated around its pivot point and secured within a stored detent of the stroller connection means 60. Retaining the shaft within the given detents is a spring biased mechanism that secures the shaft into a static position.

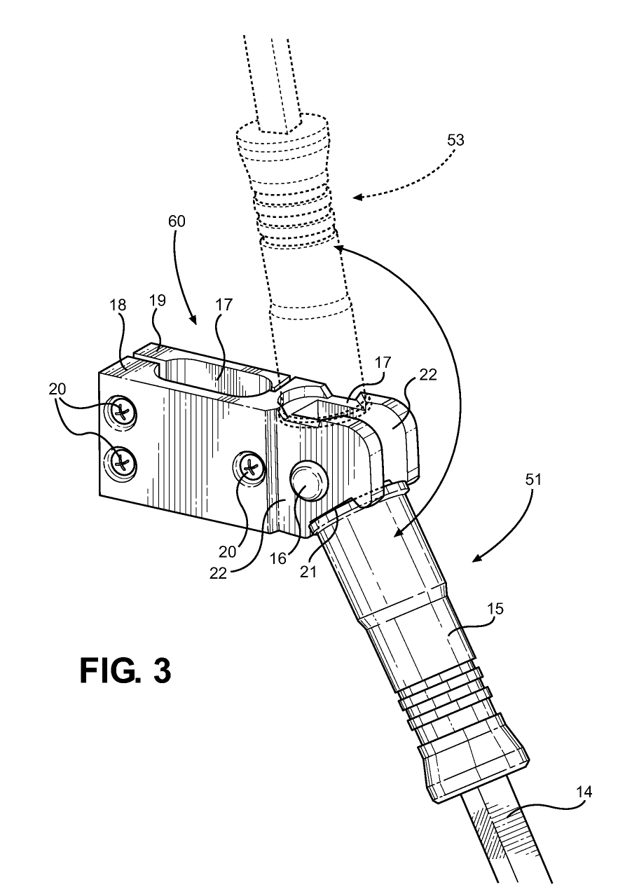

Referring now to FIG. 3, there is shown a zoomed view of the stroller connection means 60 and the deployed and stowed 53 positions for the kickstand shaft. The first end 51 of the shaft is held in one of at least two detented positions 17, 21 on the stroller connection means, whereby the shaft orientation is defined and prevented from shifting when supporting the stroller during a tipping event. The kickstand shaft rotates about its pivot joint 16 from a deployed detent 21 to stored detent 17. When the shaft is either in the stored detent 17 or the deployed detent 21, a spring biased mechanism draws a hand grip 15 within the detent and counteracts any pivoting motion of the device therefrom. If the user wants to rotate the kickstand between positions, he or she pulls the grip 15 towards the shaft second end 52 and out of the given detent. This movement will cause an internal spring to compress against a stopper within the interior of the grip and allow the grip 15 to be withdrawn from the detent 21. Once withdrawn, the shaft is rotated to a desired detent 17 and the grip 15 is then released. The spring bias draws the grip 15 into the destination detent 17 to lock the kickstand thereinto. The release of the grip 15 causes the internal spring to expand. This action secures the kickstand shaft into the new detent. During this action, the stroller connection means 60 remains secured to the stroller by way of the clamping members 18, 19 and the securing fasteners 20 therebetween.

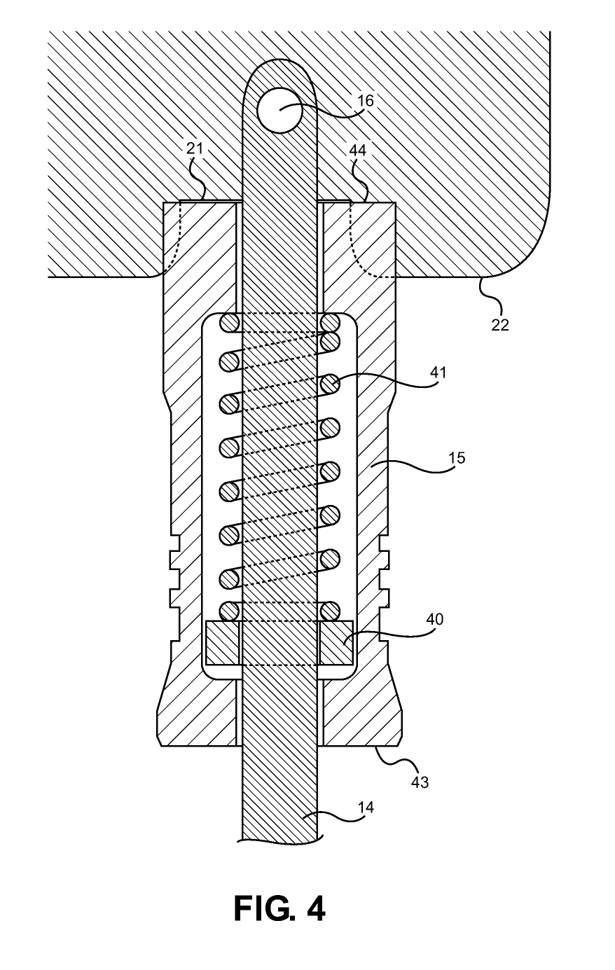

Referring finally to FIG. 4, there is shown a cross-section view of the spring biased mechanism within the detent grip 15. The mechanism grip 15 comprises a top edge 44, a bottom edge 43, and an elongated structure to allow a user to handle the grip and withdraw it from the given detent 21. The edges align with the ends of the kickstand shaft 50, while the body of the grip 15 includes an interior volume and a pathway for the kickstand shaft 14 to extend therethrough. An internal spring 41 within the grip interior is compressed between the grip upper end and a stopper element 40 along the kickstand shaft 14. The spring 41 is coiled around the kickstand shaft, while the stopper element 40 provides a base for which to compress the spring and to bias the grip 15 towards the detent 21. In use, the spring can compress or expand based on input from the user on the grip 15, whereby the grip 15 is translated along the length of the shaft 14 when pivoting the kickstand between a stowed and working position. Once the top edge 44 of the grip 15 is exposed and is outside of the detent 21, the kickstand can rotate freely about the pivot point 16.

In a typical use of the present invention, the user would have the device in its stored position while the stroller is in use. When the stroller is stopped and in need of support, the user pulls the grip 15 to withdraw it from the stored detent 17. The action would engage the spring biased mechanism and cause the grip internal spring 41 to compress against the stopper 40. The user would rotate the kickstand towards the deployed detent 21. Once aligned with the deployed detent 21, the user would release the grip 15. Upon release, the internal spring extends and forces the grip 15 securely into the deployed detent 21. At this time, the user can adjust the length of the kickstand shaft by changing the relationship between the telescoping members, sliding the lowermost telescopic shaft 14 outward to make contact with a support surface. To stabilize the telescopic shaft, the user inserts the push pin 13 into one of the apertures 28 found along the corresponding telescoping member, or further drives a set screw to secure the two members together. The stroller is thereafter stabilized by the device and can now bear additional rear weight without tipping backward.

Overall, the user of the present invention benefits in many ways. First, the present invention offers a ready solution to a common problem with strollers. The addition of a new support member to a stroller stabilizes the stroller and helps reduce incidents of tipping. Second, the present tipping support incorporates structural design element to create a compact device. A major feature of many strollers is compact design. In keeping with this desirable feature, the present invention uses minimal parts to achieve a simple device that can attach to a stroller post. The telescopic shaft further improves the compact design of the present invention by significantly reducing the size of the present invention when in its stored position. Finally, the present invention helps the user to safely complete daily tasks that would be problematic if the device is not in use. The use of the device with the stroller enables the user to carry bags while transporting a child in the stroller. When time is needed to put the bags down, the user now has a device that will help prevent a stroller from tipping when the bags are added to the rear of the stroller.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tipping body support for use with a stroller, comprising:
an elongated shaft having a first end and a second end;
said shaft first end pivotably connecting to stroller attachment means;
said shaft being capable of pivoting between a deployed state and a stored state from said attachment means;
said stroller attachment means having a spring biased mechanism for supporting said shaft in said deployed state and in said stored state;
a manual release of said spring biased mechanism for freely pivoting said shaft between said deployed and stored states.

2. The device of claim 1, wherein said elongated shaft further comprises:
a first and second telescoping member for a adjusting said elongated shaft length;
a telescoping lock mechanism for locking said first and second telescoping members together and said elongated shaft into a static length.

3. The device of claim 1, wherein said telescoping lock mechanism comprises:
a spring biased push pin connected to said first telescoping member and a plurality of aligned apertures along said second telescoping member;
said push pin inserting into one of said apertures.

4. The device of claim 1, wherein said telescoping lock mechanism comprises a set screw insertable through said first telescoping member to bear against said second telescoping member.

5. The device of claim 1, wherein said elongated shaft second end further comprises a high friction base for contact with a support surface.

6. The device of claim 1, wherein said stroller attachment means further comprises:
at least two detents for supporting said elongated shaft into either said stored or deployed state;
said spring biased mechanism biased to draw a grip member into said at least one detent for securing said elongated shaft thereinto.

7. The device of claim 1, wherein said manual release further comprises a grip member for compressing said spring biased mechanism.

8. The device of claim 1, wherein said stroller attachment means further comprises:
a first and second clamp member forming an open throughway;
said first and second clamp member fastened around a stroller support to statically support said shaft first end pivot point.

9. A tipping body support for use with a stroller, comprising:
an elongated shaft having a first end and a second end;
said shaft first end pivotably connecting to stroller attachment means;
said shaft being capable of pivoting between a deployed state and a stored state from said attachment means;
said elongated shaft further comprising a first and second telescoping member for a adjusting said elongated shaft length;
a telescoping lock mechanism for locking said first and second telescoping members together and said elongated shaft into a static length.
said push pin inserting into one of said apertures.

10. The device of claim 9, wherein:
said stroller attachment means further comprises a spring biased mechanism for supporting said shaft in at least two detents for supporting said elongated shaft into either said stored or deployed state;
a manual release of said spring biased mechanism for freely pivoting said shaft between said deployed and stored states.

11. The device of claim 10, wherein said spring biased mechanism is biased to draw a grip member into said at least one detent for securing said elongated shaft thereinto.

12. The device of claim 10, wherein said manual release further comprises a grip member for compressing said spring biased mechanism.

13. The device of claim 9, wherein said telescoping lock mechanism comprises:
a spring biased push pin connected to said first telescoping member and a plurality of aligned apertures along said second telescoping member.

14. The device of claim 9, wherein said telescoping lock mechanism comprises a set screw insertable through said first telescoping member to bear against said second telescoping member.

15. The device of claim 9, wherein said elongated shaft second end further comprises a high friction base for contact with a support surface.

16. The device of claim 9, wherein said stroller attachment means further comprises:
a first and second clamp member forming an open throughway;
said first and second clamp member fastened around a stroller support to statically support said shaft first end pivot point.
